(19) United States
(12) Patent Application Publication
(10) Pub. No.: US 2022/0365809 A1
(43) Pub. Date: Nov. 17, 2022

(54) ANALYSIS PROCESSING APPARATUS, SYSTEM, METHOD, AND NON-TRANSITORY COMPUTER READABLE MEDIUM STORING PROGRAM

(71) Applicant: NEC Corporation, Minato-ku, Tokyo (JP)

(72) Inventor: Yosuke IWAMATSU, Tokyo (JP)

(73) Assignee: NEC Corporation, Minato-ku, Tokyo (JP)

(21) Appl. No.: 17/767,206

(22) PCT Filed: Oct. 16, 2019
(86) PCT No.: PCT/JP2019/040664

§ 371 Date: Apr. 7, 2022

(51) Int. Cl. G06F 9/48

(52) U.S. Cl. CPC G06F 9/4806

(57) ABSTRACT

An analysis processing apparatus (100) includes a reception unit (110) for receiving a plurality of analysis requests requesting any of a plurality of types of analysis processing for media data, an estimation unit (120) for estimating a processing time according to the type of the analysis processing corresponding to the analysis request from an analysis condition of each analysis request for each of the plurality of analysis requests, a priority determination unit (130) for determining a priority of processing of each analysis request based on relative positioning of the estimated processing time in past records of the processing time for the type of the analysis processing corresponding to the analysis request, and an execution unit (140) for executing the analysis processing in the type corresponding to each analysis request in accordance with an order corresponding to the priority determined by the priority determination unit (130).

### TECHNICAL FIELD

The present disclosure relates to an analysis processing apparatus, system, method, and program, and more particularly to an analysis processing apparatus, system, method, and program for analyzing media data.

### BACKGROUND ART

Patent Literature 1 discloses a technique related to an image processing apparatus that processes image data acquired from a plurality of cameras in parallel. When there is an instruction of a mounting order in a plurality of consecutive recognition processes, the image processing apparatus according to Patent Literature 1 controls an insertion position into a queue, and determines a priority of tasks having the same order of priority.

Patent Literature 2 discloses a technique related to a job processing apparatus for processing print jobs requested by a plurality of users. The job processing apparatus according to Patent Literature 2 calculates a processing time of each job and determines a recommended order of execution of each job from the processing time.

Patent Literature 3 discloses a technique for predicting a processing time based on statistical data of a time required for processing on a database and transmitting a predicted value to a display unit.

In addition, in recent years, the development of base technologies of media analysis services for providing analysis processing on media data on a cloud system has been advanced. In particular, some systems that provide current media analysis services perform a plurality of types of analysis processing on various media data.

### CITATION LIST

### Patent Literature

Patent Literature 1: Japanese Unexamined Patent Application Publication No. 2014-178801

Patent Literature 2: Japanese Unexamined Patent Application Publication No. 2014-107695

Patent Literature 3: Japanese Unexamined Patent Application Publication No. S60-008969

### SUMMARY OF INVENTION

### Technical Problem

However, the present systems for providing media analysis services have a problem that variations in service quality may occur among a plurality of types of analysis processing. The reason for this is that when a plurality of analysis requests for a plurality of types of analysis processing are received, processing may be concentrated on some types of the analysis processing.

The present disclosure has been made to solve such a problem and an object of the present disclosure is to provide an analysis processing apparatus, system, method, and program for improving a request processing rate while reducing variations in service quality among a plurality of types of analysis processing.

### Solution to Problem

In a first example aspect of the present disclosure, an analysis processing apparatus includes:

reception means for receiving a plurality of analysis requests requesting any of a plurality of types of analysis processing for media data;

estimation means for estimating a processing time according to the type of the analysis processing corresponding to the analysis request from an analysis condition of each analysis request for each of the plurality of analysis requests;

priority determination means for determining a priority of processing of each analysis request based on relative positioning of the estimated processing time in past records of the processing time for the type of the analysis processing corresponding to the analysis request; and execution means for executing the analysis processing in the type corresponding to each analysis request in accordance with an order corresponding to the priority determined by the priority determination means.

In a second example aspect of the present disclosure, an analysis processing system includes:

a load balancing apparatus configured to receive a plurality of analysis requests requesting any of a plurality of types of analysis processing for media data from outside; and

a plurality of analysis processing apparatuses connected to the load balancing apparatus.

Each of the plurality of analysis processing apparatuses includes:
reception means for receiving two or more of the plurality of analysis requests dispersedly transferred from the load balancing apparatus;
estimation means for estimating a processing time according to the type of the analysis processing corresponding to the analysis request from an analysis condition of each analysis request for each of the plurality of analysis requests;
priority determination means for determining a priority of processing of each analysis request based on relative positioning of the estimated processing time in past records of the processing time for the type of the analysis processing corresponding to the analysis request; and
execution means for executing the analysis processing in the type corresponding to each analysis request in accordance with an order corresponding to the priority determined by the priority determination means.

In a second example aspect of the present disclosure, an analysis processing method performed by a computer includes:

receiving a plurality of analysis requests requesting any of a plurality of types of analysis processing for media data;

estimating a processing time according to the type of the analysis processing corresponding to the analysis request from an analysis condition of each analysis request for each of the plurality of analysis requests;

determining a priority of processing of each analysis request based on relative positioning of the estimated processing time in past records of the processing time for the type of the analysis processing corresponding to the analysis request; and

executing the analysis processing in the type corresponding to each analysis request in accordance with an order corresponding to the priority determined by the priority determination means.

In a fourth example aspect of the present disclosure, an analysis processing program causes a computer to execute:

reception processing for receiving a plurality of analysis requests requesting any of a plurality of types of analysis processing for media data;

estimation processing for estimating a processing time according to the type of the analysis processing corresponding to the analysis request from an analysis condition of each analysis request for each of the plurality of analysis requests;

priority determination processing for determining a priority of processing of each analysis request based on relative positioning of the estimated processing time in past records of the processing time for the type of the analysis processing corresponding to the analysis request; and

execution processing for executing the analysis processing in the type corresponding to each analysis request in accordance with an order corresponding to the priority determined by the priority determination means.

### Advantageous Effects of Invention

According to the present disclosure, it is possible to provide an analysis processing apparatus, system, method, and program for improving a request processing rate while reducing variations in service quality among a plurality of types of analysis processing.

### BRIEF DESCRIPTION OF DRAWINGS

FIG. 1 is a block diagram showing a configuration of an analysis processing apparatus according to a first example embodiment;

FIG. 2 is a flowchart showing a flow of an analysis processing method according to the first example embodiment;

FIG. 3 is a block diagram showing an overall configuration of a media data analysis system according to a second example embodiment;

FIG. 4 is a block diagram showing a configuration of an analysis processing server according to the second example embodiment;

FIG. 5 is a diagram for explaining a configuration and a data flow of a per-analysis priority determination unit and an update unit according to the second example embodiment;

FIG. 6 is a diagram for explaining a concept of a load distribution model and a determination criterion of a priority for each analysis type according to the second example embodiment;

FIG. 7 is a diagram for explaining a configuration of a request assign unit and a flow of data according to the second example embodiment;

FIG. 8 is a diagram for explaining a configuration of an analysis processing unit and a flow of data according to the second example embodiment;

FIG. 9 is a flowchart showing a flow of an analysis processing method according to the second example embodiment;

FIG. 10 shows an example of an analysis “a” load model according to the second example embodiment;

FIG. 11 shows an example of an analysis “b” load model according to the second example embodiment;

FIG. 12 is a diagram showing an example of an analysis type, an analysis condition, and an estimated load for each request according to the second example embodiment;

FIG. 13 shows an example of a relationship between an analysis “a” load distribution model, an analysis “b” load distribution model, estimated loads and priorities according to the second example embodiment;

FIG. 14 shows an example of a priority for each request according to the second example embodiment;

FIG. 15 shows an example of request allocation according to the second example embodiment;

FIG. 16 shows an example of an estimated waiting time and a processing result for each request according to the second example embodiment;

FIG. 17 shows an example of an estimated waiting time and a processing result for each request according to Comparative Example 1; and

FIG. 18 shows an example of an estimated waiting time for each request and the processing result according to Comparative Example 2.

### DESCRIPTION OF EMBODIMENTS

Example embodiments of the present disclosure will be described in detail below with reference to the drawings. In each of the drawings, the same or corresponding elements are denoted by the same reference signs, and repeated explanations are omitted as necessary to clarify the description.

### FIRST EXAMPLE EMBODIMENT

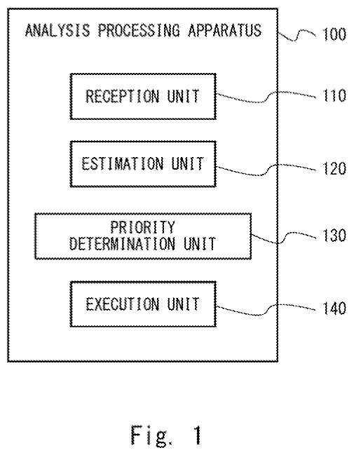

FIG. 1 is a block diagram showing a configuration of an analysis processing apparatus 100 according to a first example embodiment. The analysis processing apparatus 100 is an information processing apparatus for performing a plurality of types of analysis processing on media data. The analysis processing apparatus 100 includes a reception unit 110, an estimation unit 120, a priority determination unit 130, and an execution unit 140. The reception unit 110 is an example of reception means, the estimation unit 120 is an example of estimation means, the priority determination unit 130 is an example of priority determination means, and the execution unit 140 is an example of execution means.

The reception unit 110 receives a plurality of analysis requests requesting any of a plurality of types of analysis processing to be performed on media data. In other words, it is assumed that the reception unit 110 receives two or more analysis requests, and some of the analysis requests request at least different types of analysis processing. Further, it is assumed that the reception unit 110 receives the plurality of analysis requests at the same time or receives some analysis requests before processing at least some other the analysis requests, and two or more analysis requests are collectively processed in subsequent processing. The target media data in each analysis request is assumed to be different from each other. However, some analysis requests may request analysis processing for common media data.

The media data here is, for example, image data or voice data. The plurality of types of analysis processing are, for example, at least two or more of face recognition processing, crowd recognition processing, object recognition processing, and voice recognition processing. However, the analysis processing is not limited to them as long as it is analysis processing for media data. Also, it is assumed that the type of analysis processing, analysis conditions, and the like are designated in the analysis request. The analysis conditions include the type and size of the media data, various parameters for performing the analysis processing, and the like.

The estimation unit 120 estimates, for each of the plurality of analysis requests, a processing time according to the type of analysis processing corresponding to the analysis request from the analysis conditions. That is, the estimation unit 120 estimates the processing time from the analysis conditions in accordance with different estimation logics depending on the type of the analysis processing. Various algorithms, Artificial Intelligence (AI) models and the like can be used as an estimation logic.

The priority determination unit 130 determines a priority of processing of each analysis request based on relative positioning of the processing time estimated by the estimation unit 120 in past records of the processing time for the type of analysis processing corresponding to the analysis request. Different types of analysis processing have different past records of the processing time. Therefore, even if the estimated processing times for a plurality of analysis requests are the same, the priority may differ depending on the type of analysis processing.

The execution unit 140 executes the analysis processing in the type corresponding to each analysis request according to the order corresponding to the priority determined by the priority determination unit 130. That is, the execution unit 140 executes each analysis processing designated in each of the plurality of analysis requests in series.

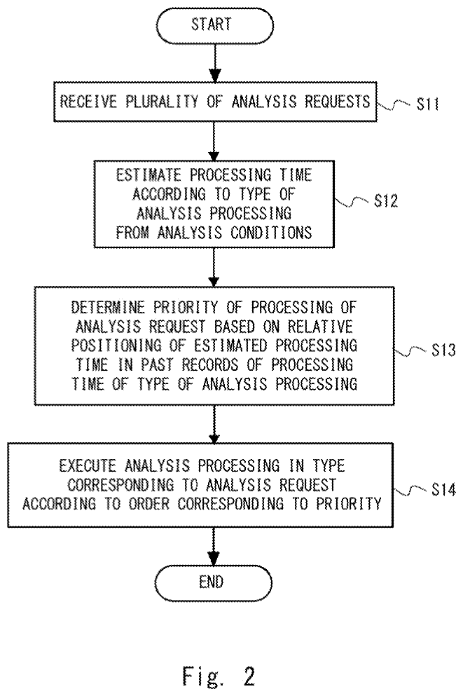

FIG. 2 is a flowchart showing a flow of the analysis processing method according to the first example embodiment. First, the reception unit 110 receives a plurality of analysis requests requesting any of a plurality of types of analysis processing for media data (S11). Next, for each of the plurality of analysis requests, the estimation unit 120 estimates a processing time according to the type of analysis processing corresponding to the analysis request from the analysis conditions in the analysis request (S12). Next, the priority determination unit 130 determines a priority of the processing of each analysis request based on relative positioning of the estimated processing time in past records of the processing time of the type of analysis processing corresponding to the analysis request (S13). After that, the execution unit 140 executes the analysis processing in the type corresponding to each analysis request according to the order corresponding to the priority determined by the priority determination unit 130 (S14).

As described above, in this example embodiment, when a plurality of analysis requests for a plurality of types of analysis processing are received, the priority of the processing is determined by different evaluation scales for different types of analysis processing. Therefore, even if the processing times estimated for the different analysis requests are the same, the priorities may differ if the types of analysis processing are different. When the analysis processing is executed, the execution order is determined by interpreting the priority as the same index (by the same evaluation scale) regardless of the type of the analysis processing. The analysis processing is sequentially executed according to the determined execution order.

Here, even when there are a plurality of analysis processing with average values of processing times greatly different from each other, the priority is determined based on a criterion for each analysis process, and at the time of execution, the type of analysis processing is cross-sectionally interpreted to determine the execution order. Therefore, for example, it is possible to prevent processing from being concentrated on some types of analysis processing with small average values of the processing times, and thus it is possible to execute each analysis processing equally or in a desired balance. It is thus possible to improve a request processing rate while reducing variations in service quality among the plurality of types of analysis processing.

The analysis processing apparatus 100 includes a processor, a memory, and a storage apparatus (not shown). The storage apparatus stores a computer program in which the processing of the analysis processing method according to this example embodiment is implemented. The processor reads the computer program from the storage apparatus into the memory and executes the computer program. In this way, the processor implements the functions of the reception unit 110, the estimation unit 120, the priority determination unit 130, and the execution unit 140.

Alternatively, each of the reception unit 110 the estimation unit 120, the priority determination unit 130, and the execution unit 140 may be implemented by dedicated hardware. Further, some or all of the constituent elements of each device may be implemented by general-purpose or dedicated circuitry, processors, etc., or a combination thereof. These constituent elements may be composed of a single chip or a plurality of chips connected via a bus. Some or all of the constituent elements of each device may be implemented by a combination of the circuitry, the program, and the like described above. The processor may be a CPU (Central Processing Unit), a GPU (Graphics Processing Unit), an FPGA (field-programmable gate array), or the like.

Further, when some or all of the constituent elements of the analysis processing apparatus 100 are implemented by a plurality of information processing apparatuses, circuitry, etc., the plurality of information processing apparatuses, circuitry, and the like, may be collectively arranged or arranged separate from each other.

For example, the information processing apparatus, the circuitry, and the like may be implemented as a form where they are connected to each other via a communication network, such as a client server system, a cloud computing system, and the like. Further, the function of the analysis processing apparatus 100 may be provided in a SaaS (Software as a Service) format.

### SECOND EXAMPLE EMBODIMENT

The problems to be solved by the present disclosure will now be described in detail.

First, in order to save resources on a cloud system, it is necessary to consolidate a plurality of types of analysis processing functions on one server. Commonly, a plurality of servers having the same function are made redundant to form a cloud system. If the plurality of types of analysis processing functions are consolidated, when the requests for a plurality of types of analysis processing are concentrated, resources (processing time) are fully utilized and thus other processing cannot be started, and a response indicating that the requested analysis processing (which could not be started) is disallowed is sent. In other words, a client is notified that the requested analysis processing is “not to be executed now”, and an execution probability of the processing (request processing rate) of the request decreases.

In the analysis processing of the media data, a load largely varies according to a data content of the analysis request (such as an image size, the number of subjects in an image, etc.). For this reason, by selectively disallowing a request estimated to have a large load (a long processing time) when the loads are concentrated, the request processing rate of the entire media analysis service can be expected to be improved.

However, if a request having a large load is simply disallowed, the percentage of disallowing only some types of analysis becomes high. That is, the quality of service varies depending on the type of analysis. For example, when the processing time of face recognition is 800 ms on average and the processing time of crowd recognition is 1500 ms on average, the rate of disallowing only the crowd recognition increases.

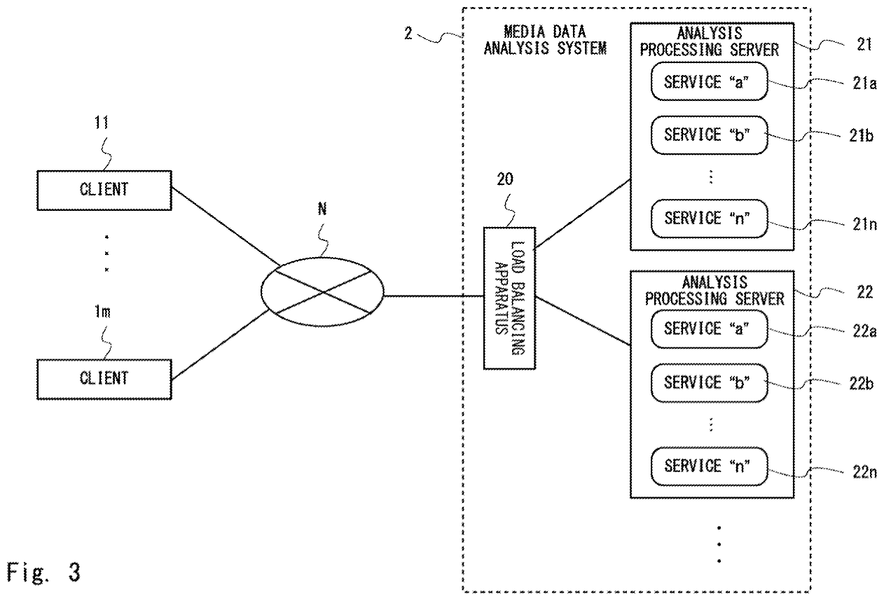

In order to address this issue, the second example embodiment shows a specific example of the first example embodiment described above, and an example embodiment that solves at least a part of the problem described above will be described below. FIG. 3 is a block diagram showing an overall configuration of a media data analysis system 2 according to the second example embodiment. The media data analysis system 2 is an information system providing a service for responding to an analysis request from the outside with an analysis result acquired by any of two or more types of analysis processing. The media data analysis system 2 is connected to one or more clients 11 to 1m (m is an integer greater than or equal to 1) via a network N.

Here, the network N is a communication line such as the Internet or a LAN (Local Area Network). Each of the clients 11 to lm transmits an analysis request requesting any of a plurality of types of analysis processing for specific media data to the media data analysis system 2 via the network N. The client 11 and the like receive a response to the analysis request from the media data analysis system 2 via the network N. Here, the response is a result of the analysis processing or a message indicating that the analysis request is disallowed.

The media data analysis system 2 includes a load balancing apparatus 20 and analysis processing servers 21, 22, . . . , and so on. The load balancing apparatus 20 receives a plurality of analysis requests from the outside and dispersedly transfers the respective analysis requests to the plurality of analysis processing servers 21 and so on. The load balancing apparatus 20 can be implemented by a known technique, and for example, a plurality of analysis requests may be transferred to the respective analysis servers in a round robin manner. For example, the load balancing apparatus 20 receives a first analysis request from the client 11 and a second analysis request from the client lm via the network N. Then, the load balancing apparatus 20 transfers, for example, the first analysis request to the analysis processing server 21 and the second analysis request to the analysis processing server 22. When the load balancing apparatus 20 continuously receives more analysis requests, the load balancing apparatus 20 may transfer two or more analysis requests to the analysis processing server 21 (regardless of whether or not the previously transferred analysis request has been processed). At this time, the types of the designated analysis processing of at least some of the two or more analysis requests are assumed to be different from each other.

The analysis processing server 21 is an information processing apparatus that provides services “a” 21a, 21b, . . . , and 21n. The analysis processing server 22 is an information processing apparatus that provides services “a” 22a, 22b, and 22n. Here, the service is a series of information processing for executing the designated analysis processing on the designated media data based on the designated analysis conditions and returning a processing result. In the example of FIG. 3, it is assumed that the service “a” 21a and the service “a” 22a are services that perform the same analysis processing, for example, crowd authentication processing. Similarly, it is assumed that the service “b” 21b and the service “b” 22b are services that perform the same analysis processing, for example, face authentication processing. Hereinafter, it is assumed that the service “n” 21n and the service “n” 22n are services that perform the same analysis processing other than crowd authentication and face authentication. That is, it is assumed that the analysis processing servers 21 and 22 and the like provides a common type of services. In the following description, when it is not particularly necessary to distinguish between the analysis processing servers 21 and 22, these are collectively referred to as the analysis processing servers 200.

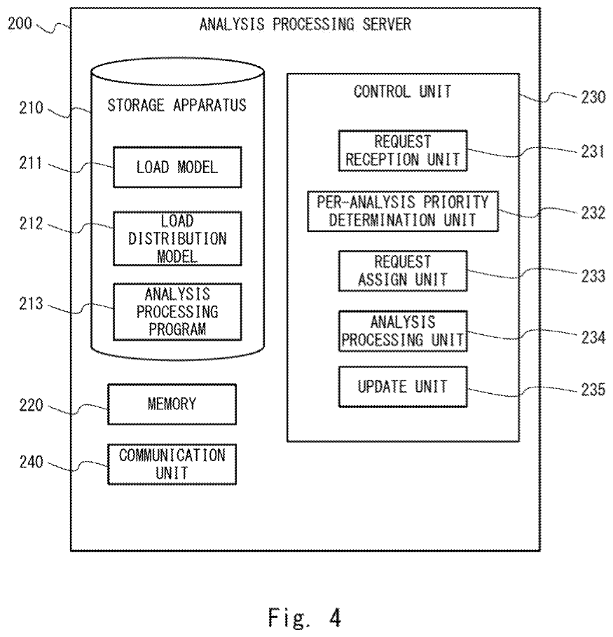

FIG. 4 is a block diagram showing a configuration of the analysis processing server 200 according to the second example embodiment. The analysis processing server 200 is implemented by, for example, a computer apparatus. The analysis processing server 200 includes a storage apparatus 210, a memory 220, a control unit 230, and a communication unit 240. The storage apparatus 210 is, for example, a hard disk or a flash memory. The storage apparatus 210 stores a load model 211, a load distribution model 212, and an analysis processing program 213.

The load model 211 is a program module or a model formula in which a logic for calculating an estimated value of the processing time of the analysis processing from the analysis conditions is implemented. For example, the load model 211 is a model which receives data conditions such as a size of an image and the number of subjects included in the image, and calculates an estimated value based on the measured value of the past processing and the past analysis conditions associated with the measured value, and then outputs the estimated value. The load model 211 is generated in advance. Alternatively, the load model 211 may be updated as described below. A plurality of the load models 211 may be provided for each type of analysis processing.

The load distribution model 212 indicates a distribution of past processing times for the type of analysis processing. For example, the load distribution model 212 is a program module or model formula that outputs a position corresponding to the estimated processing time in the distribution in response to an input of the estimated processing time. Here, the position corresponding to the estimated processing time in the distribution, for example, the number of processing times in the accumulated past processing times in order from the shortest to longest processing time, a ranking in ascending or descending order of all the past processing times, a percentage which the processing time occupies from shorter or longer processing times to the total number of processing times, and so on. The load distribution model 212 may be updated as described later. A plurality of load distribution models 212 may be provided for each type of analysis processing.

The analysis processing program 213 is a computer program in which the analysis processing method according to this example embodiment is implemented.

The memory 220 is a volatile storage apparatus such as a RAM (Random Access Memory), and is a storage area for temporarily holding information during the operation of the control unit 230. It is assumed that the memory 220 has an area for a plurality of queues associated with the plurality of respective priorities, respectively. The communication unit 240 is an interface for performing input from or output to the outside of the analysis processing server 200. For example, the communication unit 240 outputs the analysis request received via the network N to the control unit 230, and transmits the analysis result or the like to a requesting source via the network N.

The control unit 230 is a processor or a control apparatus that controls each component of the analysis processing server 200. The control unit 230 reads the analysis processing program 213 from the storage apparatus 210 into the memory 220 and executes the analysis processing program 213. In this way, the control unit 230 implements the functions of the request reception unit 231, the per-analysis priority determination unit 232, the request assign unit 233, the analysis processing unit 234, and the update unit 235. The request reception unit 231 is an example of the reception unit 110, the per-analysis priority determination unit 232 is an example of the estimation unit 120 and the priority determination unit 130, the request assign unit 233 is an example of assign means, the analysis processing unit 234 is an example of the execution unit 140, and the update unit 235 is an example of updating means.

The request reception unit 231 receives two or more of a plurality of analysis requests dispersedly transmitted from the load balancing apparatus 20. The request reception unit 231 outputs the received analysis requests to the per-analysis priority determination unit 232.

The per-analysis priority determination unit 232 specifies a position where the estimated processing time corresponds in the load distribution model 212 for the type of analysis processing for which the processing time is estimated. Then, the per-analysis priority determination unit 232 determines the priority of the processing of the analysis request based on a determination criterion corresponding to the position of each type of the corresponding analysis processing. Here, different thresholds are set for different types of analysis processing in (a range of) the determination criterion.

The request assign unit 233 stores each analysis request in a queue corresponding to the priority when the priority determined by the per-analysis priority determination unit 232 is evaluated in accordance with the same criterion among the types of analysis processing. Then, the request assign unit 233 causes the analysis processing unit 234 to preferentially execute the analysis processing corresponding to the analysis request stored in the queue having a higher priority. Further, the request assign unit 233 returns, to the requesting source, that the analysis request that has passed a predetermined period of time among the analysis requests stored in the queue cannot be processed. By doing so, a client notified that the analysis request is disallowed retransmits the disallowed analysis request, so that the analysis processing server 200 can efficiently perform the analysis processing in a time period when there is room for the analysis processing.

The analysis processing unit 234 executes the analysis processing designated in the analysis request assigned by the request assign unit 233 and returns the processing result. The analysis processing unit 234 measures the processing time when the analysis processing is executed and outputs the measured value to the update unit 235.

The update unit 235 receives the measured value of the processing time in the executed analysis processing, and updates the load distribution model 212 of the type of the analysis processing corresponding to the executed analysis processing by using the measured value. The update unit 235 may further update the load model 211 by using the measured value.

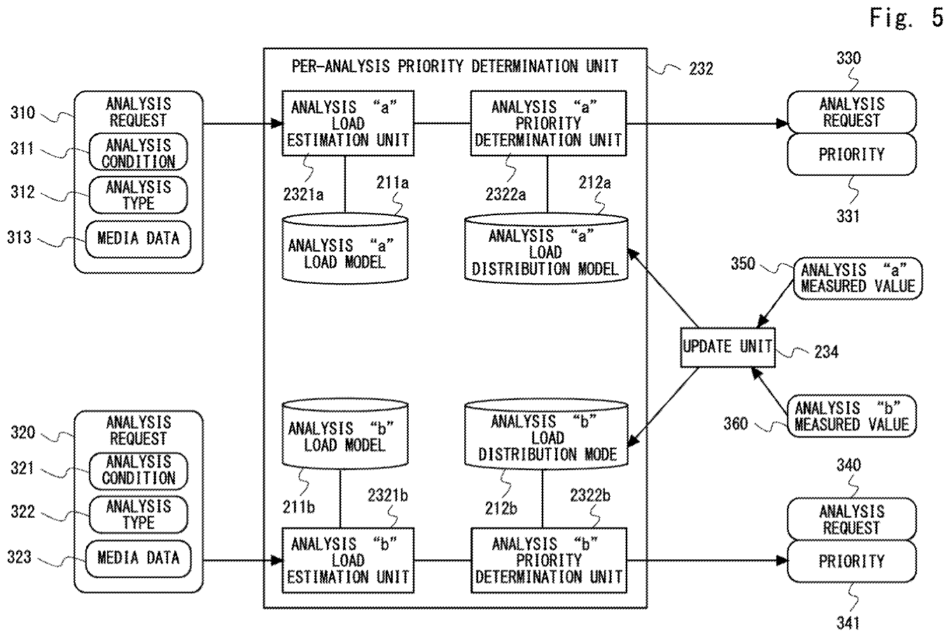

FIG. 5 is a diagram for explaining the configuration and data flow of the per-analysis priority determination unit 232 and the update unit 234 according to the second example embodiment. The per-analysis priority determination unit 232 includes an analysis “a” load estimation unit 2321a, an analysis “a” priority determination unit 2322a, an analysis “b” load estimation unit 2321b, and an analysis “b” priority determination unit 2322b. An analysis “a” load model 211a and an analysis “b” load model 211b, and the analysis “b” load model 211b and an analysis “b” load distribution model 212b are parts of the load model 211 described above. Although these components are illustrated inside the per-analysis priority determination unit 232 for convenience of explanation, they are components inside the storage apparatus 210. Similar configurations are included for analyses c to n (not shown).

An analysis request 310 indicates that an analysis condition 311, an analysis type 312, and media data 313 are designated. Note that the media data 313 may not be included in the analysis request 310. The analysis condition 311 is information indicating a condition of the media data 313 in the analysis processing, such as an image size and the number of subjects included in the image, and is, for example, the image size in this example. The analysis type 312 is, for example, crowd recognition processing. The media data 313 is, for example, image data.

An analysis request 320 indicates that an analysis condition 321, an the analysis type 322, and media data 323 are designated. The media data 323 may not be included in the analysis request 320. The analysis condition 321 is, for example, the number of subjects (the number of faces that can be recognized). The analysis type 322 is, for example, face recognition processing. The media data 323 is, for example, image data.

It is assumed that the request reception unit 231 specifies the type of analysis processing designated in the received analysis request, and outputs the analysis request to the analysis “a” load estimation units 2321a and 2321b and the like corresponding to the specified type. For example, the request reception unit 231 outputs the analysis request 310 to the analysis “a” load estimation unit 2321a and the analysis request 320 to the analysis “b” load estimation unit 2321b.

The analysis “a” load estimation unit 2321a receives the analysis request 310 from the request reception unit 231, estimates the processing time corresponding to the analysis condition 311 as a load by using the analysis “a” load model 211a, and outputs the estimated processing time to the analysis “a” priority determination unit 2322a. For example, the analysis “a” load estimation unit 2321a inputs the image size of the analysis condition 311 to the analysis “a” load model 211a and acquires the processing time as an output result to estimate the load.

The analysis “a” priority determination unit 2322a inputs an estimated value of the processing time received from the analysis “a” load estimation unit 2321a to the analysis “a” load distribution model 212a, and specifies a relative position in past values of the processing time in the analysis “a” as an output result. For example, the percentage of the number of loads accumulated in order of smallest to largest load in the past load distribution to the total measured values of analysis “a” is set as a relative position. Then, the analysis “a” priority determination unit 2322a determines the priority of the processing of the analysis request 310 by using the plurality of thresholds for the percentage in the analysis “a” as a determination criterion.

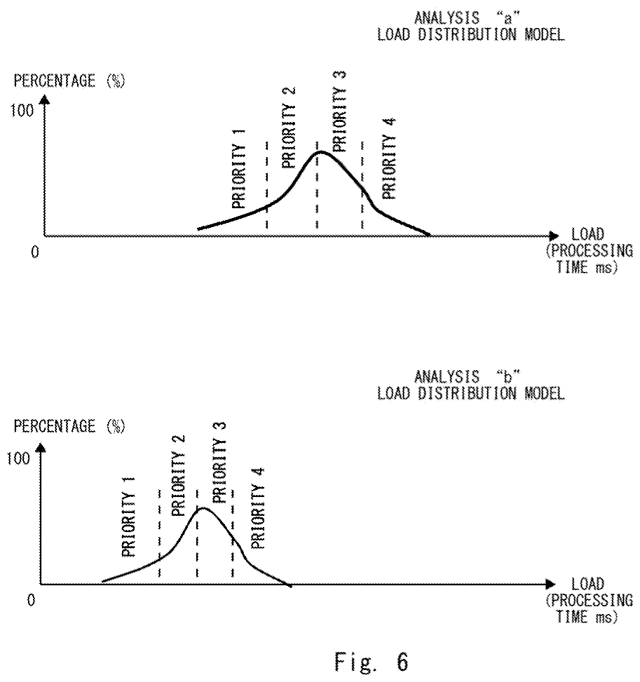

FIG. 6 is a diagram for explaining a concept of a load distribution model and a determination criterion of a priority for each analysis type according to the second example embodiment. For example, the determination criteria for determining the priority in the analysis “a” is, in order of the load, a priority 1 for the top 0% to 25%, a priority 2 for the top 25% to 50%, a priority 3 for the top 50% to 75%, and a priority 4 for the top 75% to 100%. The criteria of the analysis “b” is the same as that of the analysis “b” in this example. That is, the priority is relatively evaluated according to the position in the load distribution model for each type of analysis processing.

Referring back to FIG. 5, the description will be continued. After the priority is determined, the analysis “a” priority determination unit 2322a adds a priority 331 to the analysis request 330 (analysis request 310) and outputs the analysis request 330 (analysis request 310) to the request assign unit 233. Similar processing is performed for the analysis “b”. That is, the analysis “b” load estimation unit 2321b inputs the number of subjects designated in the analysis condition 321 to the analysis “b” load model 211b and acquires the processing time as an output result to estimate the load. The analysis “b” priority determination unit 2322b inputs an estimated value of the processing time received from the analysis “b” load estimation unit 2321b to the analysis “b” load distribution model 212b, and specifies a relative position in past values of the processing time in the analysis “b” as an output result. After the priority is determined, the analysis “b” priority determination unit 2322b adds a priority 341 to the analysis request 340 (analysis request 320) and outputs the analysis request 340 (analysis request 320) to the request assign unit 233. As shown in FIG. 6, even if the processing time of the analysis “a” is the same as that of the analysis “b”, the priority of the analysis “a” differs from that of the analysis “b”, because the load distribution models of the analyses “a” and “b” are different from each other. For example, a certain processing time may be a priority 1 for the analysis “a” but the processing time may be a priority 3 for the analysis “b”.

The update unit 235 receives an analysis “a” measured value 350 and an analysis “b” measured value 360 from the analysis processing unit 234, updates the analysis “a” load distribution model 212a by using the analysis “a” measured value 350, and updates the analysis “b” load distribution model 212b by using the analysis “b” measured value 360. Note that the update unit 235 may update the analysis “a” load model 211a by using the analysis “a” measured value 350 and update the analysis “b” load model 211b by using the analysis “b” measured value 360.

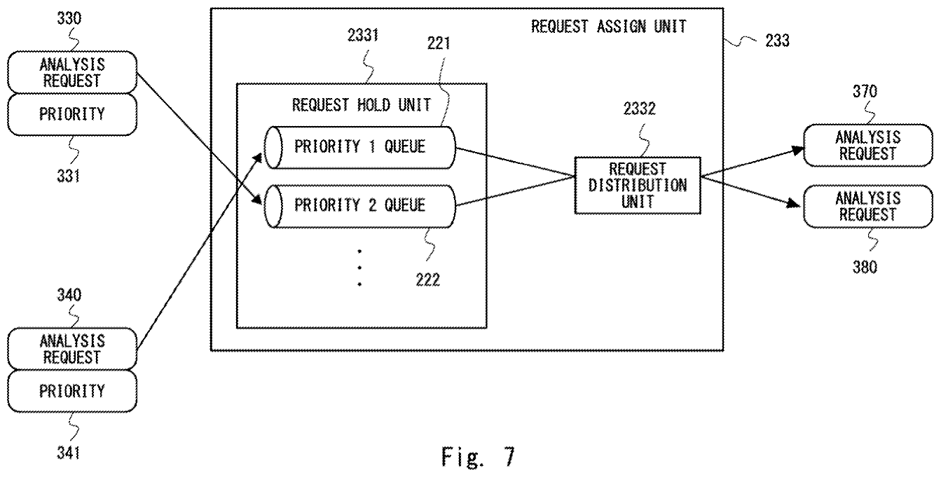

FIG. 7 is a diagram for explaining the configuration of the request assign unit 233 and the flow of data according to the second example embodiment. The request assign unit 233 includes a request hold unit 2331 and a request distribution unit 2332. The request hold unit 2331 controls a plurality of priority 1 queues 221, 222, and so on. The request hold unit 2331 sorts the analysis request to a queue corresponding to the priority added to the analysis request and then stores the analysis request. The request distribution unit 2332 acquires the analysis request from a queue having a high priority, distributes the acquired analysis request to the analysis processing unit 234 so as to process the analysis processing designated in the analysis request, and outputs the analysis request. Note that it is assumed that the priority 1 has priority over the priority 2 (the priority 1 has a higher priority than that of the priority 2). Further, the request distribution unit 2332 returns, to the requesting source, that the analysis request that has passed a predetermined period of time among the analysis requests stored in the queue cannot be processed (disallowed).

For example, when the request hold unit 2331 receives the analysis request 330, the request hold unit 2331 specifies that the added priority 331 has the priority 2, and stores the analysis request 330 in the priority 2 queue 222. When the request hold unit 2331 receives the analysis request 340, the request hold unit 2331 specifies that the added priority 341 has the priority 1, and stores the analysis request 340 in the priority 1 queue 221. The request distribution unit 2332 acquires the analysis request stored in the priority 1 queue 221 with a higher priority than those of other queues, and outputs the acquired analysis request to the analysis processing unit 234 as, for example, an analysis request 370 so as to execute processing corresponding to the type of analysis processing (e.g., crowd recognition processing) designated in the analysis request. In addition, when all the analysis requests stored in the priority 1 queue 221 have been processed, the request distribution unit 2332 acquires the analysis request stored in the priority 2 queue 222 and outputs the acquired analysis request as an analysis request 380 in a manner similar to the above (for example, to cause face recognition processing).

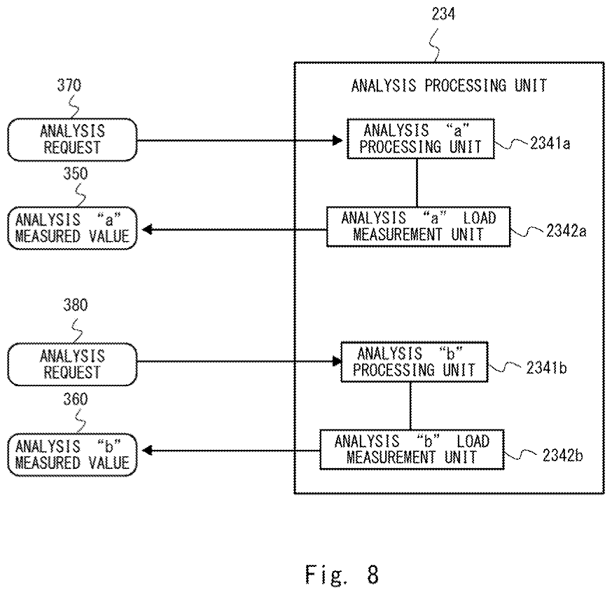

FIG. 8 is a diagram for explaining the configuration of the analysis processing unit 234 and the flow of data according to the second example embodiment. The analysis processing unit 234 includes an analysis “a” processing unit 2341a, an analysis “a” load measurement unit 2342a, an analysis “b” processing unit 2341b, and an analysis “b” load measurement unit 2342b. The analysis “a” processing unit 2341a receives the analysis request 370, executes the processing of the analysis “a” (for example, crowd recognition processing) on the designated media data, and returns the processing result to the requesting source. At this time, the analysis “a” load measurement unit 2342a measures the processing time of the analysis “a” processing unit 2341a for the analysis request 370, and outputs the measured processing time to the update unit 235 as the analysis “a” measured value 350. Similarly, the analysis “b” processing unit 2341b receives the analysis request 380, executes the processing of the analysis “b” (for example, face recognition processing) on the designated media data, and returns the processing result to the requesting source. At this time, the analysis “b” load measurement unit 2342b measures the processing time of the analysis “b” processing unit 2341b for the analysis request 380, and outputs the measured processing time to the update unit 235 as the analysis “b” measured value 360.

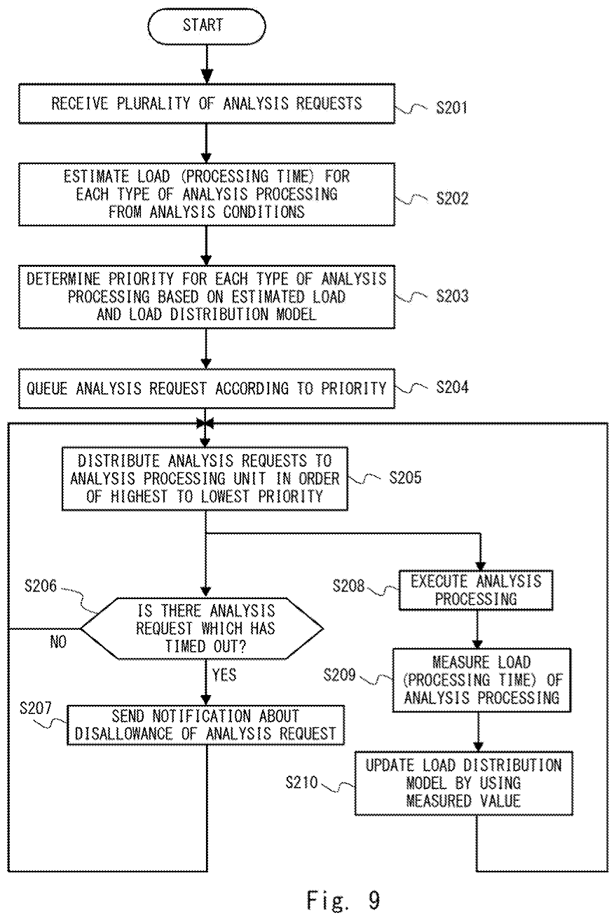

FIG. 9 is a flowchart showing the flow of the analysis processing method according to the second example embodiment. First, the request reception unit 231 receives a plurality of analysis requests from the client 11 or the like via the network N and the load balancing apparatus 20 (S201). At this time, it is assumed that the types of analysis processing designated in the plurality of analysis requests are different from each other.

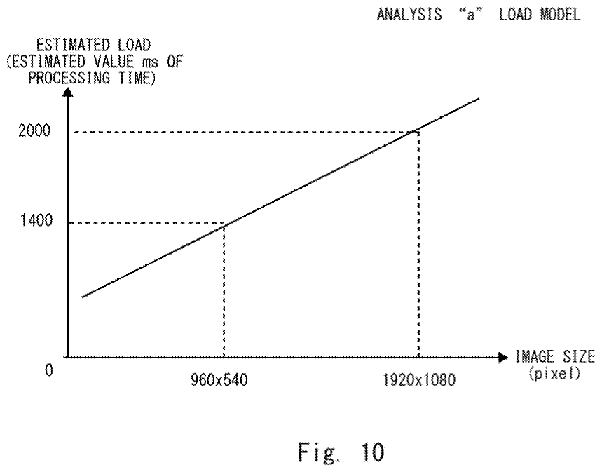

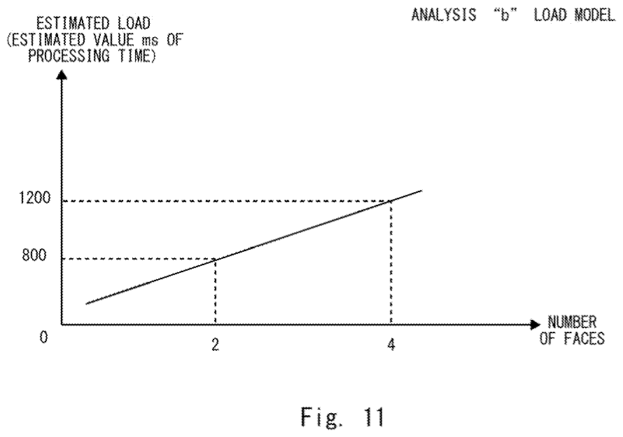

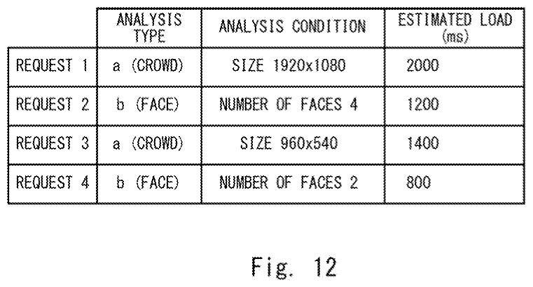

Next, the per-analysis priority determination unit 232 estimates a load (processing time) for each type of analysis processing from the analysis conditions (S202). FIG. 10 shows an example of an analysis “a” load model according to the second example embodiment. For example, the analysis “a” load estimation unit 2321a estimates the processing time to be 2000 ms when the analysis condition image size of a request 1 is 1920×1080 pixels. The analysis “a” load estimation unit 2321a estimates the processing time to be 1400 ms when the image size of the analysis condition in a request 3 is 960×540 pixels. FIG. 11 shows an example of an analysis “b” load model according to the second example embodiment. For example, the analysis “b” load estimation unit 2321b estimates the processing time to be 1200 ms when the number of faces (the number of subjects) in a request 2 is four. The analysis “b” load estimation unit 2321b estimates the processing time to be 800 ms when the number of faces in a request 4 is two. FIG. 12 shows an example of an analysis type, an analysis condition, and an estimated load for each request according to the second example embodiment.

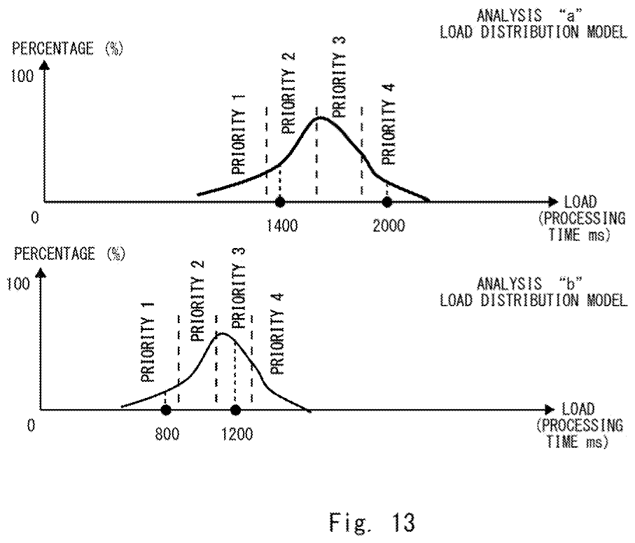

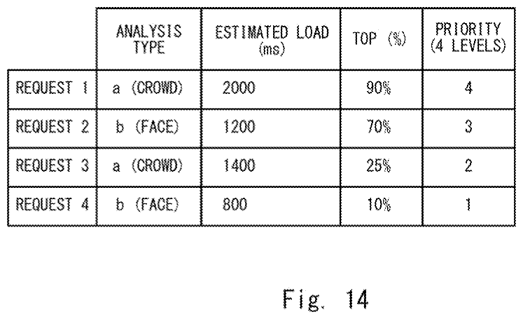

Next, the per-analysis priority determination unit 232 determines the priority for each type of analysis processing based on the estimated load and the load distribution model (S203). FIG. 13 shows an example of a relationship between the analysis “a” load distribution model, the analysis “b” load distribution model, and estimated loads and priorities according to the second example embodiment. FIG. 14 shows an example of a priority for each request according to the second example embodiment. For example, the analysis “a” priority determination unit 2322a specifies a relative position (percentage) in the analysis “a” load distribution model 212a at an estimated load of 2000 ms, accumulates the percentages of the analysis requests in order of the load, so that an accumulation percentage is calculated as being 90%. In other words, the estimated load of 2000 ms in the analysis “a” can be specified as being at a position in the top 90% from the analysis condition which the load is small. Then, the analysis “a” priority determination unit 2322a determines that the priority is 4 when the position is in the top 90% based on the above-described determination criteria. Similarly, the analysis “a” priority determination unit 2322a specifies that the position of the estimated load of 1400 ms is in the top 25% based on the analysis “a” load distribution model 212a, and determines that the priority is 2. The analysis “b” priority determination unit 2322b specifies that the position of the estimated load of 1200 ms is in the top 70% based on the analysis “b” load distribution model 212b, and determines that the priority is 3. Similarly, the analysis “b” priority determination unit 2322b specifies that the position of the estimated load of 800 ms is in the top 10% based on the analysis “b” load distribution model 212b, and determines that the priority is 1.

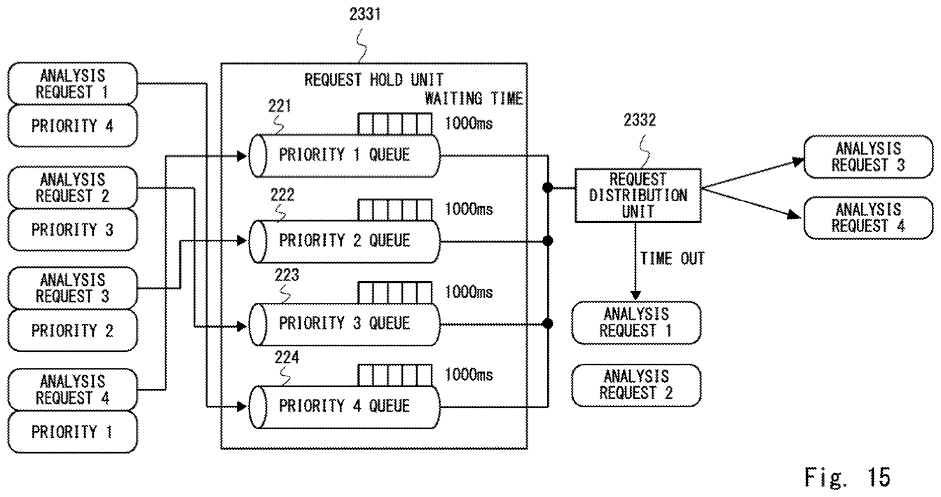

Then, the request assign unit 233 queues the analysis request according to the priority (S204). FIG. 15 is a diagram showing an example of request assignment according to the second example embodiment. Here, it is assumed that the request hold unit 2331 controls the priority 1 queue 221, the priority 2 queue 222, the priority 3 queue 223, and the priority 4 queue 224. It is assumed that requests for 1000 ms are accumulated in each queue in advance. A time-out threshold is set to 5000 ms.

For example, the request assign unit 233 assigns the analysis request 1 to which the priority 4 is added to the priority 4 queue 224 to store the analysis request 1. The request assign unit 233 assigns the analysis request 2 to which the priority 3 is added to the priority 3 queue 223 to store the analysis request 2. The request assign unit 233 assigns the analysis request 3 to which the priority 2 is added to the priority 2 queue 222 to store the analysis request 3. The request assign unit 233 assigns the analysis request 4 to which the priority 1 is added to the priority 1 queue 221 to store the analysis request 4.

Referring back to FIG. 9, the description will be continued. The request assign unit 233 distributes the analysis requests to the analysis processing unit 234 in order of highest to lowest priority (S205). First, the request distribution unit 2332 distributes the analysis requests stored in the priority 1 queue 221 in order of storage. At the time of distributing the analysis requests, the request distribution unit 2332 distributes the next analysis request stored in the priority 1 queue 221 after the previous analysis processing is completed. After the priority 1 queue 221 becomes empty, the request distribution unit 2332 distributes the analysis requests stored in the priority 2 queue 222 in order of storage, and similarly distributes the analysis requests stored in the priority 3 queue 223 and the priority 4 queue 224.

The request distribution unit 2332 determines whether there is an analysis request which has timed out (S206). For example, the request distribution unit 2332 starts measuring a waiting time from the time of storage in the queue for each analysis request, and determines that the analysis request has timed out when the waiting time exceeds the time-out threshold of 5000 ms. When it is determined that there is an analysis request which has timed out, the request distribution unit 2332 notifies the client requesting the analysis request that the analysis request is disallowed (S207). If it is determined in Step S206 that no analysis request has timed out, or after Step S207, the processing returns to Step S205.

After Step S205, in parallel with Step S206, the analysis processing unit 234 executes the analysis processing (Step S208). For example, first, the request distribution unit 2332 specifies the analysis “b” (face authentication), which is the type of analysis processing designated in the analysis request 4, and outputs the analysis request 4 to the analysis “b” processing unit 2341b corresponding to the specified analysis “b” to execute the analysis processing on the designated media data. In response to this, the analysis “b” processing unit 2341b executes the analysis processing on the media data designated in the analysis request 4.

At this time, the analysis “b” load measurement unit 2342b measures the load (processing time) of the analysis processing of the analysis request 4 by the analysis “b” processing unit 2341b (S209). Then, the analysis “b” load measurement unit 2342b outputs the measured value to the update unit 235. The update unit 235 updates the analysis “b” load distribution model 212b by using the measured value received from the analysis “b” load measurement unit 2342b (S210). After that, the processing returns to Step S205.

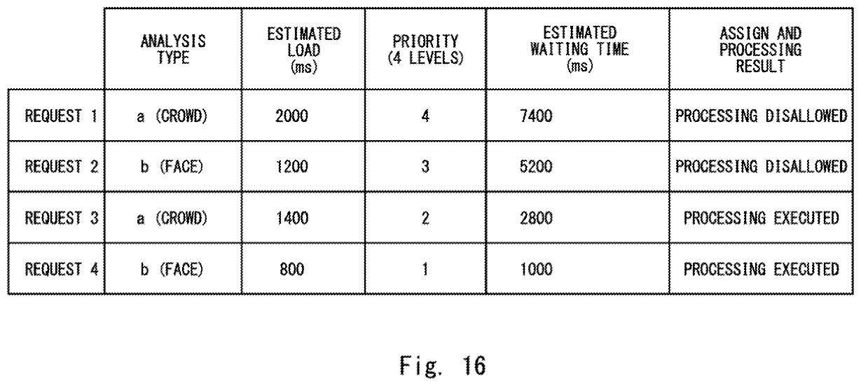

FIG. 16 shows an example of an estimated waiting time and a processing result for each request according to the second example embodiment. A description will be given with reference to FIG. 15 as appropriate. In the example of FIG. 15, the waiting time of the analysis request 4 stored in the priority 1 queue 221 is 1000 ms, because there are requests accumulated in the priority 1 queue 221. A waiting time of the analysis request 3 stored in the priority 2 queue 222 is 2800 ms, which is a sum of the waiting time 1000 ms of the priority 1 queue 221, the waiting time 800 ms of the analysis request 4, and the waiting time 1000 ms of the priority 2 queue 222. Similarly, the waiting time of the analysis request 2 stored in the priority 3 queue 223 is 5200 ms, and the waiting time 5200 ms of the analysis request 1 stored in the priority 4 queue 224 is 7400 ms. Therefore, the request distribution unit 2332 determines that the waiting times of the analysis requests 1 and 2 exceed 5000 ms of the time-out threshold, and disallows the processing.

### COMPARATIVE EXAMPLE 1

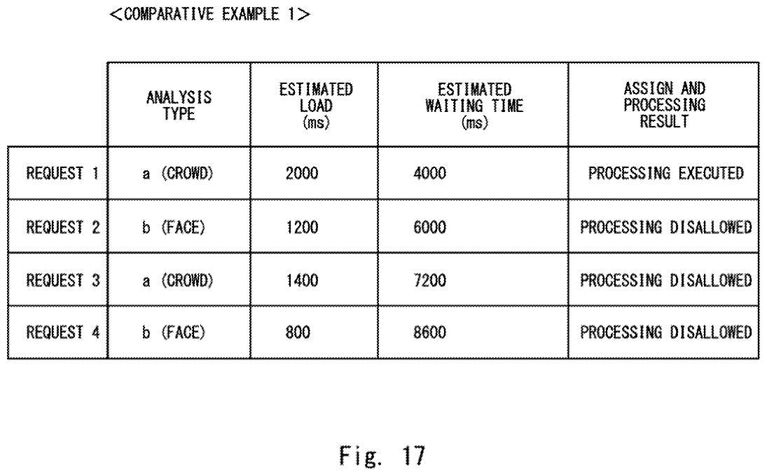

Here, a comparative example according to this example embodiment will be discussed. Comparative example 1 is about a scheme that does not prioritize queues, stores analysis requests in one queue in order of reception, and processes them in order of storage. In this case, when the conditions are the same as those in the example of FIG. 15, the waiting time of the requests accumulated in the queue is 4000 ms. It is assumed that the data is received in the order of the analysis requests 1, 2, 3, and 4. FIG. 17 shows an example of estimated waiting times and processing results in this case. First, the analysis request 1 is processed first among the four analysis requests. Thus, the waiting time of the analysis request 1 is 4000 ms. Next, the waiting time of the analysis request 2 is 6000 ms, which is a sum of the waiting time 4000 ms of the analysis request 1 and the estimated processing time 2000 ms of the analysis request 1. Similarly, the waiting time of the analysis request 3 is 7200 ms, and the waiting time of the analysis request 4 is 8600 ms. Thus, the request distribution unit 2332 determines that the waiting times of the analysis requests 1, 2, and 3 exceed 5000 ms of the time-out threshold, and disallows the processing. Therefore, the request processing rate becomes 25%. On the other hand, in the above-described example embodiment, since the analysis requests 3 and 4 are processed, the request processing rate is 50%, which is more efficient than Comparative Example 1.

### COMPARATIVE EXAMPLE 2

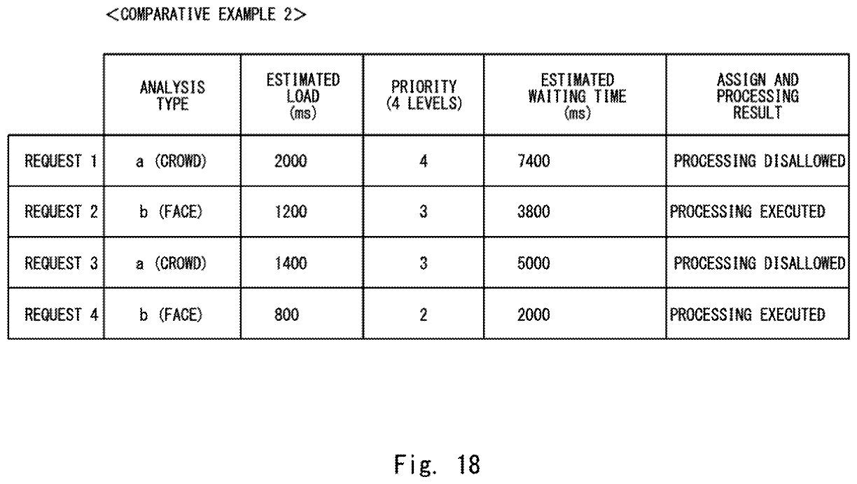

In Comparative Example 2, four prioritized queues are used as in FIG. 15, but the types of analysis processing is not considered in determination of the priorities and instead the priorities are determined by performing an absolute evaluation on the types of analysis processing. In this case, the thresholds of the criteria for determining the priority are set such that the estimated load up to 500 ms has the priority 1, the estimated load from 500 ms to 1000 ms has the priority 2, the estimated load from 1000 ms to 1500 ms has the priority 3, and the estimated load from 1500 ms to 2000 ms has the priority 4. FIG. 18 shows an example of an estimated waiting time for each request and a processing result. The estimated load of the analysis request 1 is 2000 ms, and thus the analysis request 1 has the priority 4, and is stored in the priority 4 queue 224. The estimated load of the analysis request 2 is 1200 ms and the estimated load of the analysis 3 is 1400 ms, and thus the analysis requests 2 and 3 have the priority 3, and are stored in the priority 3 queue 223. The estimated load of the analysis request 4 is 800 ms, and thus the analysis request 4 has the priority 2, and is stored in the priority 2 queue 222. The analysis request 2 is processed first among the four analysis requests. Thus, the waiting time of the analysis request 1 is 2000 ms, which is a sum of the waiting times of the priority 1 queue 221 and the priority 2 queue 222. Next, since the analysis request 2 is received before the analysis request 3, it is stored first in the priority 2 queue 222. Thus, the waiting time of the analysis request 2 is 3800 ms, which is a sum of the waiting time 2000 ms of the analysis request 4, the estimated processing time 800 ms of the analysis request 4, and the waiting time 1000 ms of the priority 3 queue 223. The waiting time of the analysis request 3 is 5000 ms, which is a sum of the waiting time 3800 ms of the analysis request 2, and the estimated processing time 1200 ms of the analysis request 2. Similarly, the waiting time of the analysis request 4 is 7400 ms. Thus, the request distribution unit 2332 determines that the waiting times of the analysis requests 1 and 3 exceed 5000 ms of the time-out threshold, and disallows the processing. Therefore, the request processing rate becomes 50%. However, the types of analysis processing of both the processed analysis requests 2 and 4 are the analysis “b” (face). On the other hand, no analysis “a” (crowd) has been processed. Therefore, in Comparative Example 2, the balance between the types of analysis processing is not favorable. On the other hand, in this example embodiment described above, since the analysis requests 3 and 4 are processed, both the analysis “a” and the analysis “b” are processed, and it can be said that the balance between the types of analysis processing is favorable.

### OTHER EXAMPLE EMBODIMENTS

In the second example embodiment, two types of analysis processing have been described, but three or more types of analysis processing may be used. In the second example embodiment, although four levels of priority are described, the priority may be any number of levels as long as it is at least two or more. Further, in the second example embodiment, the range of (thresholds) of the priorities in the determination criteria is common between the analyses “a” and “b”., and instead different range of (thresholds) of the priorities in the determination criteria may be set for different types of analysis processing.

Although the above example embodiments have been described as a hardware configuration, the present disclosure is not limited thereto. The present disclosure may be implemented by causing the CPU to execute a computer program.

In the above example, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, DVD (Digital Versatile Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above example embodiments, and may be changed as necessary without departing from the spirit thereof. The present disclosure may be implemented by appropriately combining the respective example embodiments.

The whole or part of the example embodiments disclosed above can be described as, but not limited to, the following supplementary notes.

### (Supplementary Note A1)

An analysis processing apparatus comprising:

reception means for receiving a plurality of analysis requests requesting any of a plurality of types of analysis processing for media data;

estimation means for estimating a processing time according to the type of the analysis processing corresponding to the analysis request from an analysis condition of each analysis request for each of the plurality of analysis requests;

priority determination means for determining a priority of processing of each analysis request based on relative positioning of the estimated processing time in past records of the processing time for the type of the analysis processing corresponding to the analysis request; and

execution means for executing the analysis processing in the type corresponding to each analysis request in accordance with an order corresponding to the priority determined by the priority determination means.

### (Supplementary Note A2)

The analysis processing apparatus according to Supplementary note A1, wherein

the priority determination means specifies a position where the estimated processing time corresponds in a load distribution model indicating a distribution of past processing times for the type of the analysis processing for which the processing time is estimated, and

the priority determination means determines the priority based on a determination criterion according to the position of each type of the analysis processing for which the processing time is estimated.

### (Supplementary Note A3)

The analysis processing apparatus according to Supplementary note A2, further comprising:

updating means for receiving a measured value of the processing time for the executed analysis processing and updating the load distribution model of the type of analysis processing corresponding to the executed analysis processing by using the measured value.

### (Supplementary Note A4)

The analysis processing apparatus according to Supplementary note A2 or A3, wherein

different thresholds are set for each type of the analysis processing in the determination criterion.

### (Supplementary Note A5)

The analysis processing apparatus according to any one of Supplementary notes A1 to A4, further comprising:

a plurality of queues associated with each of a plurality of the priorities; and

assign means for storing each analysis request in a queue corresponding to the priority, the priority being determined by the priority determination means and evaluated in accordance with the same criterion among the types of analysis processing, and causing the execution means to preferentially execute the analysis processing corresponding to the analysis request stored in the queue with a higher priority than those of other queues.

### (Supplementary Note A6)

The analysis processing apparatus according to Supplementary note A5, wherein

the assign means returns, to a requesting source, that the analysis request that has passed a predetermined period of time among the analysis requests stored in the queue cannot be processed.

### (Supplementary Note A7)

The analysis processing apparatus according to any one of Supplementary notes A1 to A6, wherein

the plurality of types of analysis processing include at least two or more of face recognition processing, crowd recognition processing, object recognition processing, and voice recognition processing.

### (Supplementary Note A8)

The analysis processing apparatus according to any one of Supplementary notes A1 to A7, wherein

the analysis processing apparatus is one of the plurality of servers connected to a load balancing apparatus which receives the plurality of analysis requests from the outside and dispersedly transfers the respective analysis requests to the plurality of servers.

### (Supplementary Note B1)

An analysis processing system comprising:

a load balancing apparatus configured to receive a plurality of analysis requests requesting any of a plurality of types of analysis processing for media data from outside; and

a plurality of analysis processing apparatuses connected to the load balancing apparatus, wherein

each of the plurality of analysis processing apparatuses comprises:
reception means for receiving two or more of the plurality of analysis requests dispersedly transferred from the load balancing apparatus;
estimation means for estimating a processing time according to the type of the analysis processing corresponding to the analysis request from an analysis condition of each analysis request for each of the plurality of analysis requests;
priority determination means for determining a priority of processing of each analysis request based on relative positioning of the estimated processing time in past records of the processing time for the type of the analysis processing corresponding to the analysis request; and
execution means for executing the analysis processing in the type corresponding to each analysis request in accordance with an order corresponding to the priority determined by the priority determination means.

### (Supplementary Note B2)

The analysis processing system according to Supplementary note B1, wherein

the priority determination means specifies a position where the estimated processing time corresponds in a load distribution model indicating a distribution of past processing times for the type of the analysis processing for which the processing time is estimated, and

the priority determination means determines the priority based on a determination criterion according to the position of each type of the analysis processing for which the processing time is estimated.

### (Supplementary Note C1)

An analysis processing method performed by a computer comprising:

receiving a plurality of analysis requests requesting any of a plurality of types of analysis processing for media data;

estimating a processing time according to the type of the analysis processing corresponding to the analysis request from an analysis condition of each analysis request for each of the plurality of analysis requests;

determining a priority of processing of each analysis request based on relative positioning of the estimated processing time in past records of the processing time for the type of the analysis processing corresponding to the analysis request; and

executing the analysis processing in the type corresponding to each analysis request in accordance with an order corresponding to the priority determined by the priority determination means.

### (Supplementary Note D1)

A non-transitory computer readable medium storing an analysis processing program for causing a computer to execute:

reception processing for receiving a plurality of analysis requests requesting any of a plurality of types of analysis processing for media data;

estimation processing for estimating a processing time according to the type of the analysis processing corresponding to the analysis request from an analysis condition of each analysis request for each of the plurality of analysis requests;

priority determination processing for determining a priority of processing of each analysis request based on relative positioning of the estimated processing time in past records of the processing time for the type of the analysis processing corresponding to the analysis request; and

execution processing for executing the analysis processing in the type corresponding to each analysis request in accordance with an order corresponding to the priority determined by the priority determination means.

Although the present disclosure has been described with reference to the above example embodiments (and examples), the present disclosure is not limited to the above example embodiments (and examples). Various changes can be made to the configuration and details of the present disclosure that can be understood by those skilled in the art within the scope of the present disclosure.

### Reference Signs List

100 ANALYSIS PROCESSING APPARATUS
110 RECEPTION UNIT
120 ESTIMATION UNIT
130 PRIORITY DETERMINATION UNIT
140 EXECUTION UNIT
11 CLIENT
1m CLIENT
N NETWORK
2 MEDIA DATA ANALYSIS SYSTEM
20 LOAD BALANCING APPARATUS
21 ANALYSIS PROCESSING SERVER
21a SERVICE “a”
21b SERVICE “b”
21n SERVICE “n”
200 ANALYSIS PROCESSING SERVER
22a SERVICE “a”
22b SERVICE “b”
22n SERVICE “n”
200 ANALYSIS PROCESSING SERVER
210 STORAGE APPARATUS
211 LOAD MODEL
211a ANALYSIS “a” LOAD MODEL
211b ANALYSIS “b” LOAD MODEL
212 LOAD DISTRIBUTION MODEL
212a ANALYSIS “a” LOAD DISTRIBUTION MODEL
212b ANALYSIS “b” LOAD DISTRIBUTION MODEL
213 ANALYSIS PROCESSING PROGRAM
220 MEMORY
221 PRIORITY 1 QUEUE
222 PRIORITY 2 QUEUE
223 PRIORITY 3 QUEUE
224 PRIORITY 4 QUEUE
230 CONTROL UNIT
231 REQUEST RECEPTION UNIT
232 PER-ANALYSIS PRIORITY DETERMINATION UNIT
2321a ANALYSIS “a” LOAD ESTIMATION UNIT
2322a ANALYSIS “a” PRIORITY DETERMINATION UNIT
2321b ANALYSIS “b” LOAD ESTIMATION UNIT
2322b ANALYSIS “b” PRIORITY DETERMINATION UNIT
233 REQUEST ASSIGN UNIT
2331 REQUEST HOLD UNIT
2332 REQUEST DISTRIBUTION UNIT
234 ANALYSIS PROCESSING UNIT
2341a ANALYSIS “a” PROCESSING UNIT
2342a ANALYSIS “a” LOAD MEASUREMENT UNIT
2341b ANALYSIS “b” PROCESSING UNIT
2342b ANALYSIS “b” LOAD MEASUREMENT UNIT
235 UPDATE UNIT
240 COMMUNICATION UNIT
310 ANALYSIS REQUEST
311 ANALYSIS CONDITION
312 ANALYSIS TYPE
313 MEDIA DATA
320 ANALYSIS REQUEST
321 ANALYSIS CONDITION
322 ANALYSIS TYPE
323 MEDIA DATA
330 ANALYSIS REQUEST
331 PRIORITY
340 ANALYSIS REQUEST
341 PRIORITY
350 ANALYSIS “a” MEASURED VALUE
360 ANALYSIS “b” MEASURED VALUE
370 ANALYSIS REQUEST
380 ANALYSIS REQUEST

What is claimed is:

1. An analysis processing apparatus comprising:
at least one memory configured to store instructions; and
at least one processor configured to execute the instructions to:
receive a plurality of analysis requests requesting any of a plurality of types of analysis processing for media data;
estimate a processing time according to the type of the analysis processing corresponding to the analysis request from an analysis condition of each analysis request for each of the plurality of analysis requests;
determine a priority of processing of each analysis request based on relative positioning of the estimated processing time in past records of the processing time for the type of the analysis processing corresponding to the analysis request; and
execute the analysis processing in the type corresponding to each analysis request in accordance with an order corresponding to the priority determined by the priority determination means.

2. The analysis processing apparatus according to claim 1, wherein the at least one processor is further configured to execute the instructions to:
specify a position where the estimated processing time corresponds in a load distribution model indicating a distribution of past processing times for the type of the analysis processing for which the processing time is estimated, and
determine the priority based on a determination criterion according to the position of each type of the analysis processing for which the processing time is estimated.

3. The analysis processing apparatus according to claim 2, wherein the at least one processor is further configured to execute the instructions to:
receive a measured value of the processing time for the executed analysis processing and updating update the load distribution model of the type of analysis processing corresponding to the executed analysis processing by using the measured value.

4. The analysis processing apparatus according to claim 2, wherein
different thresholds are set for each type of the analysis processing in the determination criterion.

5. The analysis processing apparatus according to claim 1, further comprising:
a plurality of queues associated with each of a plurality of the priorities; and
wherein the at least one processor is further configured to execute the instructions to:
store each analysis request in a queue corresponding to the priority, the priority determined priority being evaluated in accordance with the same criterion among the types of analysis processing, and
preferentially execute the analysis processing corresponding to the analysis request stored in the queue with a higher priority than those of other queues.

6. The analysis processing apparatus according to claim 5, wherein the at least one processor is further configured to execute the instructions to:
return, to a requesting source, that the analysis request that has passed a predetermined period of time among the analysis requests stored in the queue cannot be processed.

7. The analysis processing apparatus according to claim 1, wherein
the plurality of types of analysis processing include at least two or more of face recognition processing, crowd recognition processing, object recognition processing, and voice recognition processing.

8. The analysis processing apparatus according to claim 1, wherein
the analysis processing apparatus is one of the plurality of servers connected to a load balancing apparatus which receives the plurality of analysis requests from the outside and dispersedly transfers the respective analysis requests to the plurality of servers.

9-10. (canceled)

11. An analysis processing method performed by a computer comprising:
receiving a plurality of analysis requests requesting any of a plurality of types of analysis processing for media data;
estimating a processing time according to the type of the analysis processing corresponding to the analysis request from an analysis condition of each analysis request for each of the plurality of analysis requests;
determining a priority of processing of each analysis request based on relative positioning of the estimated processing time in past records of the processing time for the type of the analysis processing corresponding to the analysis request; and
executing the analysis processing in the type corresponding to each analysis request in accordance with an order corresponding to the priority determined by the priority determination means.

12. A non-transitory computer readable medium storing an analysis processing program for causing a computer to execute:
reception processing for receiving a plurality of analysis requests requesting any of a plurality of types of analysis processing for media data;
estimation processing for estimating a processing time according to the type of the analysis processing corresponding to the analysis request from an analysis condition of each analysis request for each of the plurality of analysis requests;
priority determination processing for determining a priority of processing of each analysis request based on relative positioning of the estimated processing time in past records of the processing time for the type of the analysis processing corresponding to the analysis request; and
execution processing for executing the analysis processing in the type corresponding to each analysis request in accordance with an order corresponding to the priority determined by the priority determination means.
